(19) United States
(12) Patent Application Publication
(10) Pub. No.: US 2022/0166907 A1
(43) Pub. Date: May 26, 2022

(54) INFRARED AND VISIBLE LIGHT IMAGING MODULE ARRANGEMENT FOR IMPROVED IMAGE PROCESSING

(71) Applicant: FLIR Systems AB, Täby (SE)

(72) Inventors: Tomas Hallgren, Täby (SE); Erik Zarmen, Täby (SE); Kark Martensson, Stockholm (SE); Bengt Ehrenkrona, Bromma (SE)

(21) Appl. No.: 17/599,734

(22) PCT Filed: Mar. 27, 2020
(86) PCT No.: PCT/US2020/025283

§ 371 Date: Sep. 29, 2021

Related U.S. Application Data
(60) Provisional application No. 62/826,159, filed on Mar. 29, 2019.

(51) Int. Cl. H04N 5/225; G06T 5/50; H04N 5/247; H04N 7/01; H04N 5/232

(52) U.S. Cl. CPC H04N 5/2258; G06T 5/50; H04N 5/247; G06T 2207/20212; H04N 5/23232; G06T 2207/10048; H04N 7/0117

(57) ABSTRACT

Various techniques are provided for implementing an imaging system with multiple infrared imaging modules provided in proximity to a visible light imaging module with overlapping fields of view. In one example, a system includes an array of infrared imaging modules configured to capture infrared images overlapping in a shared field of view of the array. The system also includes a visible light imaging module configured to capture a visible light image with a field of view overlapping with the shared field of view of the array. The system also includes a logic device configured to process the infrared images to provide an increased resolution infrared image corresponding to the shared field of view of the array, and generate a combined image comprising content from the increased resolution infrared image and content from the visible light image. Additional methods and systems are also provided.

### CROSS-REFERENCE TO RELATED APPLICATIONS

This application claims priority to and benefit of U.S. Provisional Patent Application No. 62/826,159 filed Mar. 29, 2019 and entitled “INFRARED AND VISIBLE LIGHT IMAGING MODULE ARRANGEMENT FOR IMPROVED IMAGE PROCESSING,” which is hereby incorporated by reference in its entirety.

### TECHNICAL FIELD

The present invention relates generally to infrared and visible light imaging and, more particularly, to systems and methods for combining infrared and visible light images.

### BACKGROUND

Various types of imaging devices may be used for capturing images of particular wavelength ranges. For example, infrared imagers may be implemented with microbolometers and/or other technologies for capturing images of infrared wavelengths, while visible light imagers may be implemented with charge coupled devices, CMOS devices, and/or other technologies for capturing images of visible light wavelengths.

The different technologies employed by imagers associated with various wavelengths can result in the imagers exhibiting different resolutions when implemented with the same or similar form factors. For example, for small form factor imagers (e.g., sized for implementation in a phone or other device), infrared imagers may exhibit lower resolutions than visible light imagers of the same or similar form factor.

In such cases, when infrared and visible light images are captured of the same scene, the infrared images may exhibit substantially lower resolution than the visible light images. This can be problematic when infrared images and visible light images are processed together. For example, if the infrared and visible light images are combined with each other, the resulting images may be compromised by the lower resolution of the infrared images.

### SUMMARY

In accordance with various embodiments discussed herein, an array of infrared imaging modules may be provided in proximity to a visible light imaging module to support enhanced imaging. For example, multiple infrared imaging modules may be positioned to have overlapping fields of view to provide infrared images with a higher resolution than would be available from the infrared imaging modules individually. In addition, the visible light imaging module may also be positioned to have an overlapping field of view with that of the multiple infrared imaging modules. As a result, high resolution infrared images and visible light images may be captured of the same scene and combined or otherwise processed to provide resulting processed images of high resolution.

In one embodiment, a system includes an array of infrared imaging modules configured to capture infrared images overlapping in a shared field of view of the array; a visible light imaging module configured to capture a visible light image with a field of view overlapping with the shared field of view of the array; and a logic device configured to: process the infrared images to provide an increased resolution infrared image corresponding to the shared field of view of the array, and generate a combined image comprising content from the increased resolution infrared image and content from the visible light image.

In another embodiment, a method includes capturing, by an array of infrared imaging modules, infrared images overlapping in a shared field of view of the array; capturing, by a visible light imaging module, a visible light image with a field of view overlapping with the shared field of view of the array; processing the infrared images to provide an increased resolution infrared image corresponding to the shared field of view of the array, and generating a combined image comprising content from the increased resolution infrared image and content from the visible light image.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system in accordance with an embodiment of the disclosure.

FIG. 2 illustrates a block diagram of an imaging module in accordance with an embodiment of the disclosure.

FIG. 3 illustrates an arrangement of infrared imaging modules and a visible light imaging module in accordance with an embodiment of the disclosure.

FIG. 4 illustrates an isometric view of overlapping fields of view associated with infrared imaging modules and a visible light imaging module in accordance with an embodiment of the disclosure.

FIG. 5 illustrates a top view of overlapping fields of view associated with infrared imaging modules and a visible light imaging module in accordance with an embodiment of the disclosure.

FIG. 6 illustrates infrared imaging modules and a visible light imaging module implemented in a camera system in accordance with an embodiment of the disclosure.

FIG. 7 illustrates another arrangement of infrared imaging modules and a visible light imaging module in accordance with an embodiment of the disclosure.

FIG. 8 illustrates a process of operating an imaging system in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

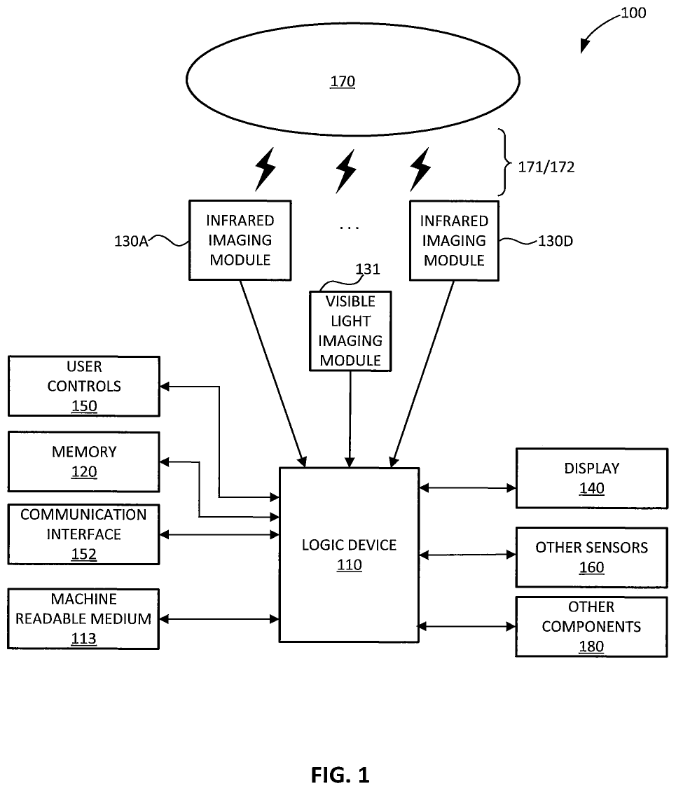

FIG. 1 illustrates a block diagram of an imaging system 100 in accordance with an embodiment of the disclosure. Imaging system 100 may include a plurality of infrared imaging modules 130, a visible light imaging module 131, a logic device 110, a machine-readable medium 113, a memory 120, a display 140, user controls 150, a communication interface 152, other sensors 160, and other components 180.

Infrared imaging modules 130 may be used to capture infrared images (e.g., infrared image frames) in response to infrared radiation 171 received from scene 170. Infrared imaging modules 130 may be configured to capture infrared images corresponding to various wavelength bands including, for example, near-infrared, short-wavelength infrared, mid-wavelength infrared, long-wavelength infrared, and/or thermal infrared wavelengths. As further discussed herein and illustrated in exampling embodiments provided in additional figures, infrared imaging modules 130 may be arranged in an array such that at least a portion of their various fields of view overlap with each other to provide a shared field of view. By processing the infrared images captured by the various infrared imaging modules 130, increased resolution infrared images may be generated that have a higher resolution in the shared field of view than that of the original infrared images captured by individual infrared imaging modules 130.

In the embodiment shown in FIG. 1, four infrared imaging modules 130 are contemplated, which are individually labeled 130A through 130D. However, it will be understood that any desired number of infrared imaging modules 130 (e.g., greater or fewer numbers) may be used and appropriately arranged to provide overlapping fields of view as discussed herein.

Visible light imaging module 131 may be used to capture visible light images (e.g., visible light image frames) in response to visible light radiation 172 received from scene 170. Although a single visible light imaging module 131 is illustrated, additional visible light imaging modules 131 may be provided with fields of view that overlap with each other and infrared imaging modules 130.

As further discussed herein and illustrated in exampling embodiments provided in additional figures, visible light imaging module 131 may be arranged with infrared imaging modules 130 such that at least a portion of the field of view of visible light imaging module 131 overlaps with the shared field of view of infrared imaging modules 130. As further discussed herein, the visible light images may be combined with the increased resolution infrared images to provide combined images comprising content from both the increased resolution infrared images and content from the visible light images.

Such techniques may be used to advantageously provide combined images that include high resolution content associated with infrared wavelengths and visible light wavelengths. In this regard, it will be understood that infrared images typically provided by conventional imaging systems generally exhibit lower resolution than visible light images provided by imagers having a similar form factor. Thus, when conventional infrared images are combined with conventional visible light images, the visible light content generally exhibits a much higher resolution than the infrared content. As a result, when conventional low resolution infrared content is combined with conventional high resolution visible light content, the infrared content may appear less precise and less informative to a user.

By generating high resolution infrared images using a plurality of infrared imaging modules 130 having overlapping fields of view corresponding to a shared field of view, the resulting high resolution infrared images associated with the shared field of view may be advantageously combined with high resolution visible light images to provide combined images that exhibit high resolution content for both infrared wavelengths and visible light wavelengths, thus improving the accuracy and quality of the resulting combined images.

Logic device 110 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), and/or any other appropriate combinations of devices and/or memory to perform any of the various operations described herein. Logic device 110 is configured to interface and communicate with the various components illustrated in FIG. 1 to perform method and processing steps as described herein. In various embodiments, processing instructions may be integrated in software and/or hardware as part of logic device 110, or code (e.g., software and/or configuration data) which may be stored in memory 120 and/or a machine readable medium 113. In various embodiments, the instructions stored in memory 120 and/or machine-readable medium 113 permit logic device 110 to perform the various operations discussed herein and/or control various components of system 100 for such operations.

Memory 120 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, fixed memory, removable memory, and/or other types of memory.

Machine readable medium 113 (e.g., a memory, a hard drive, a compact disk, a digital video disk, or a flash memory) may be a non-transitory machine-readable medium storing instructions for execution by logic device 110. In various embodiments, machine readable medium 113 may be included as part of imaging system 100 and/or separate from imaging system 100, with stored instructions provided to imaging system 100 by coupling the machine readable medium 113 to imaging system 100 and/or by imaging system 100 downloading (e.g., via a wired or wireless link) the instructions from the machine readable medium (e.g., containing the non-transitory information).

Logic device 110 may be configured to process captured infrared images and visible light images, and provide them to display 140 for viewing by a user. Display 140 may include a display device such as a liquid crystal display (LCD), an organic light-emitting diode (OLED) display, and/or other types of displays as appropriate to display images and/or information to a user of system 100. Logic device 110 may be configured to display images and information on display 140. For example, logic device 110 may be configured to retrieve images and information from memory 120 and provide images and information to display 140 for presentation to a user of system 100. Display 140 may include display electronics, which may be utilized by logic device 110 to display such images and information.

User controls 150 may include any desired type of user input and/or interface device having one or more user actuated components, such as one or more buttons, slide bars, knobs, keyboards, joysticks, and/or other types of controls that are configured to generate one or more user actuated input control signals. In some embodiments, user controls 150 may be integrated with display 140 as a touchscreen to operate as both user controls 150 and display 140. Logic device 110 may be configured to sense control input signals from user controls 150 and respond to sensed control input signals received therefrom. In some embodiments, portions of display 140 and/or user controls 150 may be implemented by appropriate portions of a tablet, a laptop computer, a desktop computer, and/or other types of devices.

In various embodiments, user controls 150 may be configured to include one or more other user-activated mechanisms to provide various other control operations of imaging system 100, such as auto-focus, menu enable and selection, field of view (FoV), brightness, contrast, gain, offset, spatial, temporal, and/or various other features and/or parameters.

Imaging system 100 may include various types of other sensors 160 including, for example, motion sensors (e.g., accelerometers, vibration sensors, gyroscopes and/or others), microphones, navigation sensors (e.g., global positioning system (GPS) sensors), and/or other sensors as appropriate.

Logic device 110 may be configured to receive and pass infrared images from infrared imaging modules 130, visible light images from visible light imaging module 131, additional data from sensors 160, and control signal information from user controls 150 to one or more external devices through communication interface 152 (e.g., through wired and/or wireless communications). In this regard, communication interface 152 may be implemented to provide wired communication over a cable and/or wireless communication over an antenna. For example, communication interface 152 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network. As such, communication interface 152 may include an antenna coupled thereto for wireless communication purposes. In other embodiments, the communication interface 152 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, imaging system 100 and/or its individual associated components may be associated with a particular network link such as for example a URL (Uniform Resource Locator), an IP (Internet Protocol) address, and/or a mobile phone number.

Imaging system 100 may include various other components 180 such as speakers, displays, visual indicators (e.g., recording indicators), vibration actuators, a battery or other power supply (e.g., rechargeable or otherwise), and/or additional components as appropriate for particular implementations.

In some embodiments, system 100 may be implemented as a portable camera. However, other embodiments are also contemplated. For example, although various features of imaging system 100 are illustrated together in FIG. 1, any of the various illustrated components and subcomponents may be implemented in a distributed manner and used remotely from each other as appropriate. For example, various subcomponents of camera 101 may be implemented separately and from each other in some embodiments.

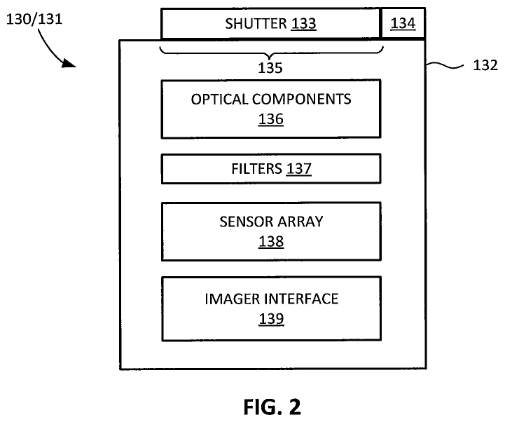

FIG. 2 illustrates a block diagram of an imaging module 130/131 in accordance with an embodiment of the disclosure. In this regard, it will be appreciated that the various features illustrated in FIG. 2 may be used to implement one or more of infrared imaging modules 130 and/or visible light imaging module 131. However, the specific implementations of the different types of modules may vary as appropriate for infrared imaging modules 130 or visible light imaging module 131.

As shown, imaging module 130/131 may include a housing 132, a shutter 133, an actuator 134, sensor array 138, optical components 136, filters 137, and/or an imager interface 139. Housing 132 permits imaging module 130/131 to be implemented as a discrete small form factor imager that may be readily combined with other imaging modules to provide an array of imaging modules. In some embodiments, imaging module 130/131 may be implemented in accordance with any of the embodiments set forth in U.S. Pat. No. 8,766,808 and/or U.S. Pat. No. 10,091,439, all of which are incorporated herein in their entirety.

Optical components 132 (e.g., one or more lenses) receive infrared radiation 171 and/or visible light radiation 172 from scene 170 through an aperture 135 and pass the radiation to filters 137 and sensor array 138. Filters 133 (e.g., one or more long pass, short pass, band pass and/or other filters) operate to restrict infrared radiation 171 and/or visible light radiation 172 to limited wavelength ranges for imaging.

Sensor array 138 may include an array of sensors (e.g., any type of infrared, visible light, or other types of detectors) for capturing images of scene 170. For example, in the case of infrared imaging modules 130, sensor array 138 may be implemented by an array of microbolometers and/or other appropriate technology. As another example, in the case of visible light imaging module 131, sensor array 138 may be implemented by an array of charge-coupled device sensors and/or other appropriate technology.

In some embodiments, sensor array 138 may also include one or more analog-to-digital converters for converting analog signals captured by the sensors into digital data (e.g., pixel values) to provide the captured images. Image interface 139 provides captured images to logic device 110 which may be used to process the images, store the original and/or processed images in memory 120, and/or retrieve stored images from memory 120.

Shutter 133 may be selectively positioned (e.g., through the operation of actuator 134 under the control of logic device 110) in front of optical components 136, filters 137, and/or sensor array 138 to block infrared radiation 171 and/or visible light radiation 172 from being received by sensor array 138. For example, actuator 106 may position to shutter 133 to block aperture 135 such that imager 130 may capture images of shutter 133 for calibration purposes. For example, in some embodiments, shutter 133 may provide a temperature controlled black body surface facing sensor array 138 that is captured in one or more images by sensor array 138 to determine correction values for rows, columns, and/or individual pixels associated with the sensors of sensor array 138. Actuator 134 may also position shutter 133 to not block aperture 135 and thus permit sensor array 138 to capture images of infrared radiation 171 and/or visible light radiation 172 received from scene 170 when calibration is not taking place.

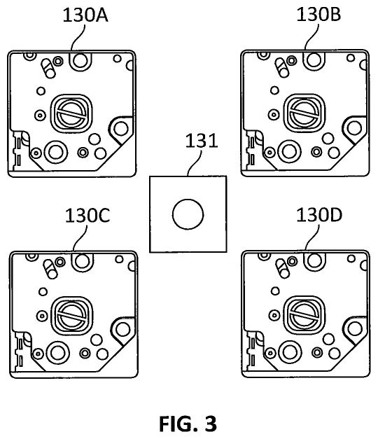

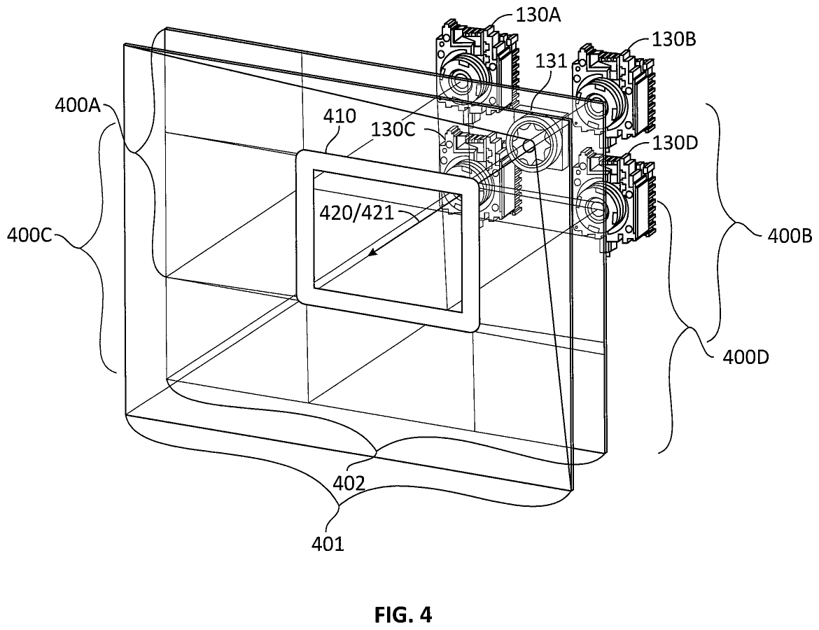

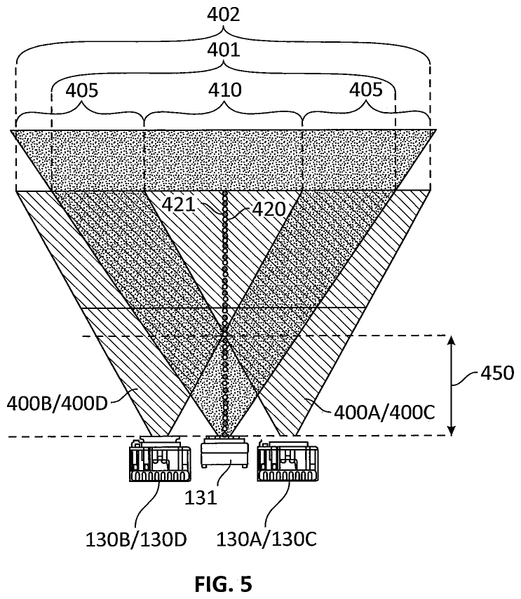

FIG. 3 illustrates an arrangement of infrared imaging modules 130 and a visible light imaging module 131 in accordance with an embodiment of the disclosure. FIG. 4 illustrates an isometric view of the arrangement of FIG. 3, and FIG. 5 illustrates a top view of the arrangement of FIG. 3, in accordance with embodiments of the disclosure.

Referring now to FIGS. 3, 4, and 5, an array of four infrared imaging modules 130A, 130B, 130C, and 130D are positioned around visible light imaging module 131. In this regard, infrared imaging modules 130A-D define a perimeter within which visible light imaging module 131 is positioned. Advantageously, such an arrangement can provide for overlapping fields of view among infrared imaging modules 130A-D and visible light imaging module 131.

Each of infrared imaging modules 130A, 130B, 130C, and 130D has a corresponding field of view 400A, 400B, 400C, and 400D, respectively. These fields of view 400A-D (e.g., also referred to as cones) overlap with each other in a shared field of view 410 (e.g., also referred to as a cone). As a result, infrared images captured by infrared imaging modules 130A-D will include overlapping portions corresponding to the shared field of view 410. The overlapping infrared images may be processed to provide increased resolution infrared images corresponding to the shared field of view 410, as further discussed herein.

Visible light imaging module 131 has a corresponding field of view 401 (e.g., also referred to as a cone) that overlaps with the fields of view 400A-D of infrared imaging modules 130A-D. Significantly, the field of view 401 of visible light imaging module 131 overlaps with the shared field of view 410 of infrared imaging modules 130A-D. Thus, visible light images captured by visible light imaging module 131 will include portions that correspond to the increased resolution infrared images corresponding to the shared field of view 410. As a result of this arrangement, images may be generated that combine visible light image content with higher resolution infrared image content than would otherwise be available using a single infrared imaging module 130 implemented with a similar form factor as visible light imaging module 131.

The total combined field of view 402 of all infrared imaging modules 130A-D includes the combination of all fields of view 400A-D. These fields of view 400A-D overlap in a shared field of view 410 which begins at distance 450 from infrared imaging modules 130A-D (e.g., the closest plane to infrared imaging modules 130A-D where their fields of view 400A-D overlap with each other). Thus, this shared field of view 410 represents the positions of scene 170 that can be imaged with increased resolution through appropriate processing of overlapping infrared images. Thus, in some embodiments, increased resolution infrared images may be generated for portions of scene 170 that fall within shared field of view 410, while standard resolution (e.g., lower resolution) infrared images may be provided for portions 405 of scene 170 (see FIG. 5) that fall within the combined field of view 402 but outside the shared field of view 410.

As shown, in some embodiments, the field of view 401 of visible light imaging module 131 may completely overlap the shared field of view 410 of infrared imaging modules 130A-D. As a result, combined images including high resolution infrared content and visible light content may be generated for the entirety of shared field of view 410 in such cases.

Thus, distance 450 represents the closest plane to infrared imaging modules 130A-D and visible light imaging module 131 for which such combined images may be generated. Advantageously, the positioning of visible light imaging module 131 within a perimeter defined by the array of infrared imaging modules 130A-D permits distance 450 to be minimized and closer to modules 130A-D/131 than would otherwise be possible if visible light imaging module 131 were instead positioned outside the perimeter.

In some embodiments, visible light imaging module 131 may be substantially centered within the array of infrared imaging modules 130A-D such that the field of view 401 of the visible light imaging module 131 has a visual center within the shared field of view 410 of the array of infrared imaging modules 130A-D. In some embodiments, an optical axis 421 associated with the field of view 401 of visible light imaging module 131 is substantially aligned with an optical axis 420 associated with the shared field of view 410 of the array of infrared imaging modules 130A-D (e.g., see FIGS. 4 and 5).

Moreover, such alignment of the optical axes 420/421 permits the visible light images captured by visible light imaging module 131 and the increased resolution infrared images provided by processing the infrared images captured by infrared imaging modules 130A-D to exhibit minimal or no parallax relative to each other. This improves the accuracy of combined images generated therefrom.

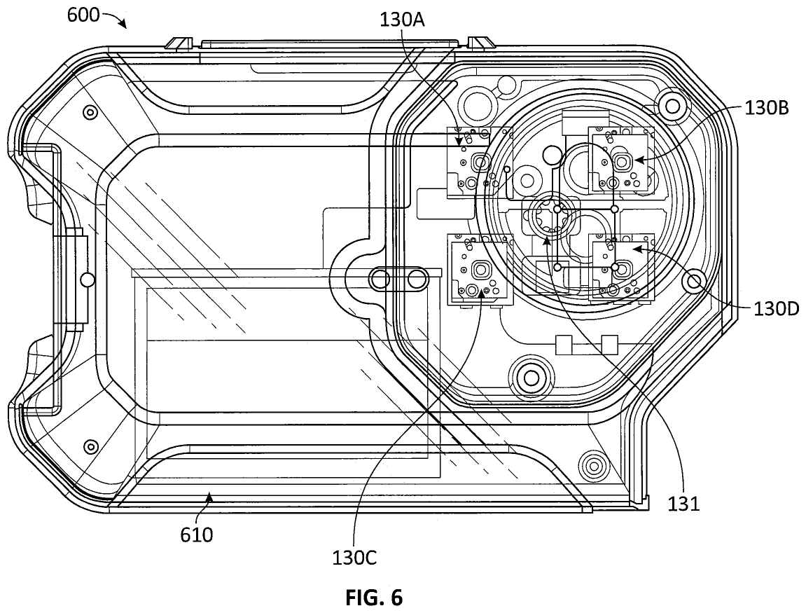

FIG. 6 illustrates infrared imaging modules 130A-D and visible light imaging module 131 implemented in a camera system 600 in accordance with an embodiment of the disclosure. For example, in one or more embodiments, the various components of system 100 may be combined into camera system 600 which may be implemented as a portable camera having a housing 610 as shown in FIG. 6. Other embodiments are also contemplated.

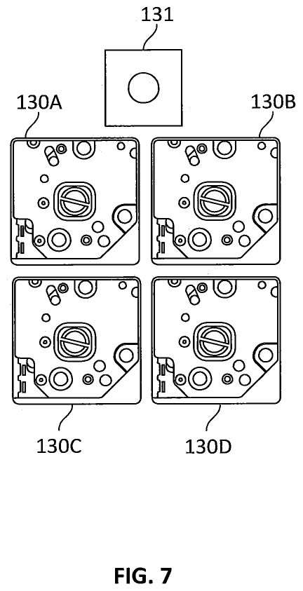

FIG. 7 illustrates another arrangement of infrared imaging modules 130A-D and visible light imaging module 131 in accordance with an embodiment of the disclosure. In FIG. 7, visible light imaging module 131 is positioned in proximity to (e.g., adjacent to) the array of infrared imaging modules 130A-D. In this case, although visible light imaging module 131 is not positioned within a perimeter defined by the array of infrared imaging modules 130A-D, its field of view 401 may nevertheless still overlap with the shared field of view 410 of infrared imaging modules 130A-D, and with a greater distance 450 than provided by the embodiment illustrated in FIG. 5.

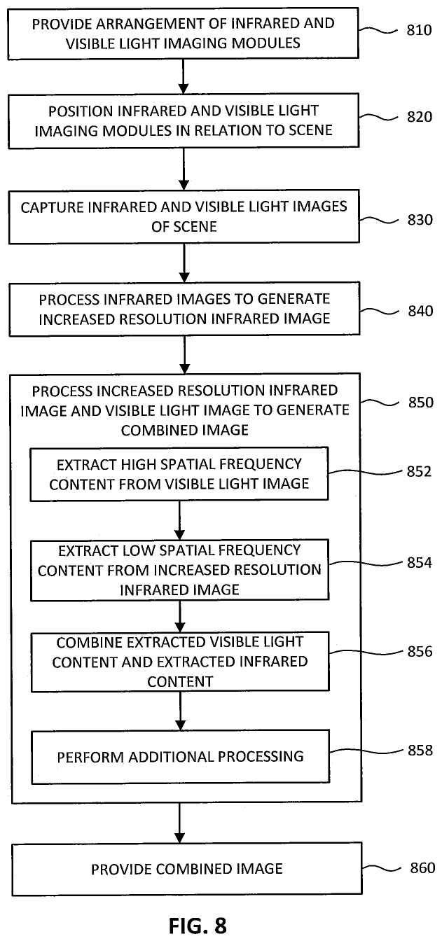

FIG. 8 illustrates a process of operating an imaging system in accordance with an embodiment of the disclosure. In block 810, a plurality of infrared imaging modules 130 are arranged in an array and visible light imaging module 131 is arranged relative to the array. For example, block 810 may include the manufacture of a portable camera 600 that includes imaging system 100. In block 810, in some embodiments, visible light imaging module 131 may be positioned within a perimeter defined by the array of infrared imaging modules 130 as shown in FIGS. 3-6. In other embodiments, visible light imaging module 131 may be positioned adjacent to the array of infrared imaging modules 130 as shown in FIG. 7. Other arrangements are also contemplated.

In block 820, the array of infrared imaging modules 130 and visible light imaging module 131 are positioned in relation to scene 170. For example, in the case of imaging system 100 implemented in a portable camera 600, block 820 may include a user positioning the portable camera 600 to capture images of a desired portion of scene 170.

In block 830, the array of infrared imaging modules 130 and visible light imaging module 131 capture corresponding infrared and visible light images of scene 170. In some embodiments, the infrared images and the visible light image may be captured simultaneously. In other embodiments, one or more of the infrared images and/or the visible light image may be captured at different times (e.g., if it is desired to capture different wavelength bands at different times, such as during day or night).

In block 840, logic device 110 processes the infrared images captured by the array of infrared imaging modules 130 (e.g., the low resolution infrared images) to generate an increased resolution infrared image (e.g., a high resolution infrared image) associated with shared field of view 410. In this regard, various techniques may be used to generate the increased resolution infrared image through appropriate processing of the low resolution infrared images. In some embodiments, the processing performed in block 840 may include any of the various techniques set forth in U.S. Pat. No. 8,766,808 and/or U.S. Pat. No. 10,091,439, all of which are hereby incorporated by reference herein in their entirety. In some embodiments, such processing may include, for example, super resolution processing (e.g., using phase shifts among the low resolution infrared images), stereo imaging processing of the low resolution infrared images, artificial neural network processing of the low resolution infrared images, and/or other processing as appropriate.

In block 850, logic device 110 processes the increased resolution infrared image (e.g., generated in block 840) and the visible light image (e.g., captured in block 830) to generate a combined image comprising infrared image content and visible light image content. In some embodiments, the processing performed in block 850 may include any of the various techniques set forth in U.S. Pat. Nos. 8,520,970, 8,565,547, 8,749,635, 9,171,361, 9,635,285, and/or 10,091,439, all of which are hereby incorporated by reference in their entirety. In some embodiments, such processing may include, for example, contrast enhancement processing (e.g., also referred to as MSX processing, high contrast processing, and/or fusion processing), true color processing, triple fusion processing, alpha blending, and/or other processing as appropriate.

FIG. 8 further illustrates example blocks 852 to 858 that identify several examples of processing operations that may be performed in block 850 to generate a combined image. It will be understood that such blocks are provided only for purposes of example, and that additional, fewer, and/or different operations may be performed in block 850 as appropriate for particular implementations.

In block 852, logic device 110 extracts high spatial frequency content from the visible light image. For example, in some embodiments, this may include applying a high pass filter to the visible light image.

In block 854, logic device 110 extracts low spatial frequency content from the increased resolution infrared image. For example, in some embodiments, this may include applying a low pass filter to the increased resolution infrared image.

In block 856, logic device 110 combines the visible light content and the infrared content extracted in blocks 852 and 854. In block 858, logic device 110 performs additional processing as may desired to further adjust the combined image including, for example, any of the various processing set forth in the patents that have been incorporated by reference into this disclosure.

In block 860, logic device 110 provides the combined image generated in block 850. In various embodiments, this may include storing the combined image in memory 120, transmitting the combined image over communication interface 152, displaying the combined image on display 140, and/or other actions as appropriate. In various embodiments, the blocks of FIG. 8 may be repeated as appropriate to provide additional combined images as desired.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A system comprising:
an array of infrared imaging modules configured to capture infrared images overlapping in a shared field of view of the array;
a visible light imaging module configured to capture a visible light image with a field of view overlapping with the shared field of view of the array; and
a logic device configured to:
process the infrared images to provide an increased resolution infrared image corresponding to the shared field of view of the array, and
generate a combined image comprising content from the increased resolution infrared image and content from the visible light image.

2. The system of claim 1, wherein the field of view of the visible light imaging module has a visual center within the shared field of view of the array.

3. The system of claim 1, wherein an optical axis associated with the field of view of the visible light imaging module is substantially aligned with an optical axis associated with the shared field of view of the array.

4. The system of claim 1, wherein the visible light imaging module is positioned within a perimeter defined by the array.

5. The system of claim 1, wherein the array comprises at least four infrared imaging modules.

6. The system of claim 1, wherein the system is implemented by a portable camera.

7. The system of claim 1, wherein the infrared images and the visible light image are captured simultaneously.

8. The system of claim 1, wherein the logic device is configured to:
extract the content from the visible light image; and
combine the content from the visible light image with the content from the increased resolution infrared image to generate the combined image.

9. The system of claim 8, wherein the content from the visible light image comprises high spatial frequency content.

10. The system of claim 8, wherein the content from the increased resolution infrared image comprises low spatial frequency content.

11. A method comprising:
capturing, by an array of infrared imaging modules, infrared images overlapping in a shared field of view of the array;
capturing, by a visible light imaging module, a visible light image with a field of view overlapping with the shared field of view of the array;
processing the infrared images to provide an increased resolution infrared image corresponding to the shared field of view of the array, and
generating a combined image comprising content from the increased resolution infrared image and content from the visible light image.

12. The method of claim 11, wherein the field of view of the visible light imaging module has a visual center within the shared field of view of the array.

13. The method of claim 11, wherein an optical axis associated with the field of view of the visible light imaging module is substantially aligned with an optical axis associated with the shared field of view of the array.

14. The method of claim 11, wherein the visible light imaging module is positioned within a perimeter defined by the array.

15. The method of claim 11, wherein the array comprises at least four infrared imaging modules.

16. The method of claim 11, wherein the system is implemented by a portable camera.

17. The method of claim 11, wherein the infrared images and the visible light image are captured simultaneously.

18. The method of claim 11, wherein the generating comprises:
extracting the content from the visible light image; and
combining the extracted content from the visible light image with the content from the increased resolution infrared image.

19. The method of claim 18, wherein the content from the visible light image comprises high spatial frequency content.

20. The method of claim 11, wherein the content from the increased resolution infrared image comprises low spatial frequency content.
